(19) United States
(12) Patent Application Publication
(10) Pub. No.: US 2008/0205505 A1
(43) Pub. Date: Aug. 28, 2008

(54) VIDEO CODING WITH MOTION VECTORS DETERMINED BY DECODER

(76) Inventor: Donald Martin Monro, Beckington (GB)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/678,004

(22) Filed: Feb. 22, 2007

(51) Int. Cl. H04B 1/66

(52) U.S. Cl. 375/240

(57) ABSTRACT

A method, system, and apparatus for video coding in regards to motion data, particularly with vectors determined by a decoder are disclosed. A method of video decoding where part of a reference image frame is compared with a portion of the image frame to be compensated and the comparison allows for determination of a motion vector. An encoder which provides to a decoder in the form of a data bitstream, a portion of an image frame, allowing the decoder to determine a motion. A decoder which be determining motion vectors produces at least some of an image frame. A system for video coding having both an encoder and a decoder.

### BACKGROUND

Digital video services, such as transmitting digital video information over wireless transmission networks, digital satellite services, streaming video over the internet, delivering video content to personal digital assistants or cellular phones, etc., are gaining in popularity. Increasingly, digital video compression and decompression techniques may be implemented that balance visual fidelity with compression levels to allow efficient transmission and storage of digital video content. Techniques that more resourcefully generate and/or convey motion information may help improve transmission efficiencies.

### BRIEF DESCRIPTION OF THE DRAWINGS

Subject matter is particularly pointed out and distinctly claimed in the concluding portion of the specification. Claimed subject matter, however, both as to organization and method of operation, together with objects and features thereof, may best be understood by reference of the following detailed description if read with the accompanying drawings in which:

FIG. 1 is a flow diagram of a process for video decoding;

FIG. 2 is a conceptualization of an example video encoding scheme;

FIG. 3 is a conceptualization of an example video decoding scheme;

FIG. 4 is a flow diagram of a process for video decoding;

FIG. 5 illustrates an example encoding system;

FIG. 6 illustrates an example decoding system; and

FIGS. 7-8 illustrate example systems.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Some portions of the following detailed description are presented in terms of algorithms and/or symbolic representations of operations on data bits and/or binary digital signals stored within a computing system, such as within a computer and/or computing system memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing may involve physical manipulations of physical quantities. Typically, although not necessarily, these quantities may take the form of electrical, magnetic and/or electromagnetic signals capable of being stored, transferred, combined, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device, that manipulates and/or transforms data represented as physical electronic and/or magnetic quantities and/or other physical quantities within the computing platform's processors, memories, registers, and/or other information storage, transmission, and/or display devices.

Motion compensation may be used to improve compression of video data. In general, motion compensation may permit portions of a predicted video frame to be assembled from portions of a reference frame and associated motion data describing displacement of those reference frame portions with respect to the predicted frame. Motion data may comprise motion vectors describing displacement of a portion of image data from, for example, a reference video frame, to another video frame, for example a predicted frame, occurring later in a video sequence. Thus, for example, a motion vector may describe how a particular portion of a reference frame may be displaced horizontally and/or vertically with respect to a subsequent frame.

For example, a video transmission system may, in part, implement motion compensation by having an encoder convey and/or transmit a bitstream to a decoder where the bitstream may include a sequence of compressed reference frames and compressed motion vectors referring to portions of the reference frame and associated with certain subsequent frames to be generated by a decoder. A decoder may then decode the bitstream and use motion vectors to assemble portions of predicted frames from those portions of the reference frame that the motion vectors refer to. An encoder may also send compressed error or Displaced Frame Difference (DFD) frames that a decoder may decode and use to generate a predicted frame in conjunction with motion vectors. In some implementations this may be done by assembling portions of a predicted frame from portions of a reference frame referred to by motion vectors and subsequently adding a DFD frame to correct for errors.

Motion vectors may be used to describe the displacement of portions and/or regions of video frames of varying sizes and/or shapes. Video data comprising image frames may include data in either spatial or temporal domains. Video data comprising an image may include coefficients resulting from spatial, temporal, or spatio-temporal transforms. The video data may be raw image data, wavelet transformed image data, or other types, formats or configurations of image data. Overall, there are a multitude of schemes for implementing motion compensated video compression and claimed subject matter is not limited to particular motion compensation schemes nor to particular types and/or forms of video data. Some more common motion compensation schemes include those implemented under the Motion Picture Experts Group (MPEG) and/or Video Coding Experts Group (VCEG) standards organizations such as, for example, the H.264 standard INCITS/ISO/IEC 14496-10:2005.

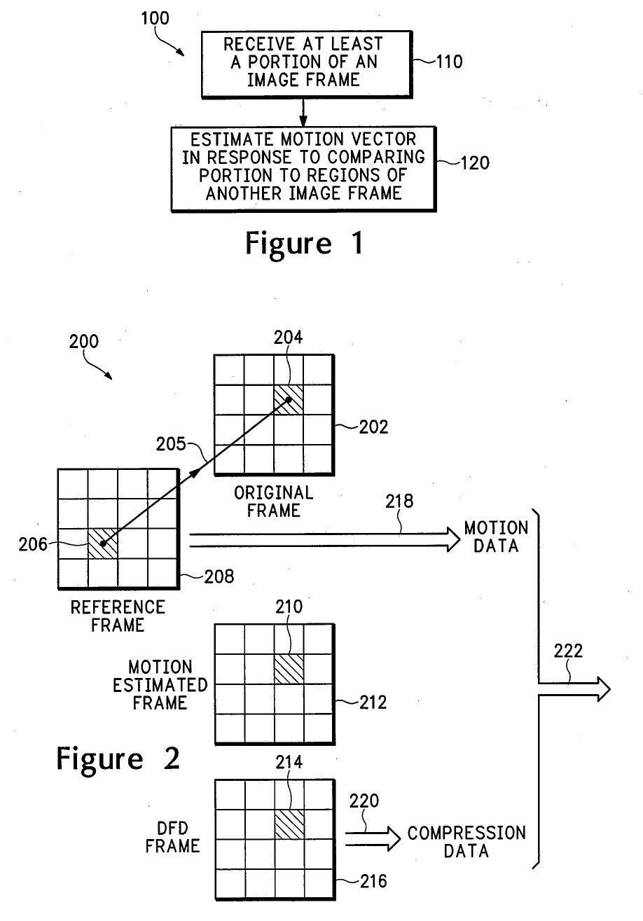

FIG. 1 is a flow diagram of a process 100 for video decoding. In block 110, a portion of an image or image frame may be received. In block 120, a motion vector may be estimated in response to comparing a portion of an image frame received in block 110 to a plurality of portions of a reference image or frame. As described in more detail hereinafter, a method is described wherein a decoder may determine motion vectors in response, at least in part, to image data received from an encoder. Thus, for example, in some implementations of claimed subject matter, a decoder may implement block 120 by comparing a portion of an image frame received in block 110 to portions or regions of a reference frame and subsequently estimate a motion vector as will be explained in greater detail below. A method of having a decoder receive a portion of an image frame and then estimate a motion vector in response to comparing that portion to portions of another frame may yield more efficient compression of video data.

In some implementations, an image frame including a portion received in block 110 may comprise a DFD frame as will be explained in greater detail below. While, in some implementations, another frame employed in block 120 may comprise a reference frame (e.g., an “intra” or I-frame), although claimed subject matter is not limited in scope in this regard. It may be recognized however, that frame portions received in block 110 (e.g., a DFD frame portion) may be of a different size and/or extent than the portions or regions of another image frame (e.g., a reference frame portion) compared to in block 120. Further, the example implementation of FIG. 1 may include all, more than all, and/or less than all of blocks 110-120, and, furthermore, the order of blocks 110-120 is merely an example order, and the scope of claimed subject matter is not limited in this respect.

FIG. 2 is a conceptualization of an example video encoding scheme 200. Scheme 200 is presented for the purposes of generally describing motion estimation in video encoding and is not intended to limit claimed subject matter in any way. In scheme 200, an encoder and/or an encoding system may undertake motion compensated encoding of an original frame 202 by matching, using any one of a number of well known motion estimation techniques, a portion 204 of frame 202 with a portion 206 of a reference frame 208. As those skilled in the art will recognize, reference frame 208 may comprise a video frame that an encoder has previously encoded and then decoded using an internal decoding mechanism. Thus, in some implementations, reference frame 208 may, for example, comprise a decoded compressed still image based on an original frame located earlier in a video sequence, or may comprise a prediction of an earlier frame.

When an encoder has identified a matching portion 206, the encoder may establish a displacement value or motion vector 205 describing a displacement required to map portion 206 onto portion 204. In this manner, a portion 210 of a motion estimated frame 212 may be produced by copying image data of portion 206 displaced by vector 205. However, doing so may not yield a perfect match to portion 204 of an original image and, hence, a portion 214 of a DFD frame 216 may be generated by subtracting image data of portion 210 from image data of portion 204 of original frame 202. In this context, portion 210 may be described as “corresponding” to portion 204 because portions 204 and 210 occupy a same location in respective frames 212 and 202. Similarly, portion 214 may be described as corresponding to portions 204 and/or 210.

Having undertaken scheme 200 for portions of an original frame or for portions of a number of original frames, an encoder may then transmit information indicative of motion data 218, such as a motion vector 205, and information indicative of image data 220, such as of DFD frame 216, to a decoder. An encoder may transmit such information in a bitstream 222 carrying coded motion data and coded image data.

Objects, elements, quantities etc. shown in scheme 200 are not necessarily intended to be shown to scale, and/or exhaustive in all details. For example, while reference frame 202, as shown, comprises sixteen image portions, those skilled in the art will recognize that an image or frame may, in fact, comprise a larger number of portions comprising, for example, macroblocks having 4,096 discrete pixel values, although claimed subject matter is not limited to any particular type, format and/or shape of image or frame portions. While a variety of well-known methods for determining motion vectors may be employed to implement a scheme like scheme 200, claimed subject matter is not limited in scope to any particular motion compensation scheme. Moreover, claimed subject matter is not limited in scope to particular types of image frames and/or sizes or orientations of image frame portions.

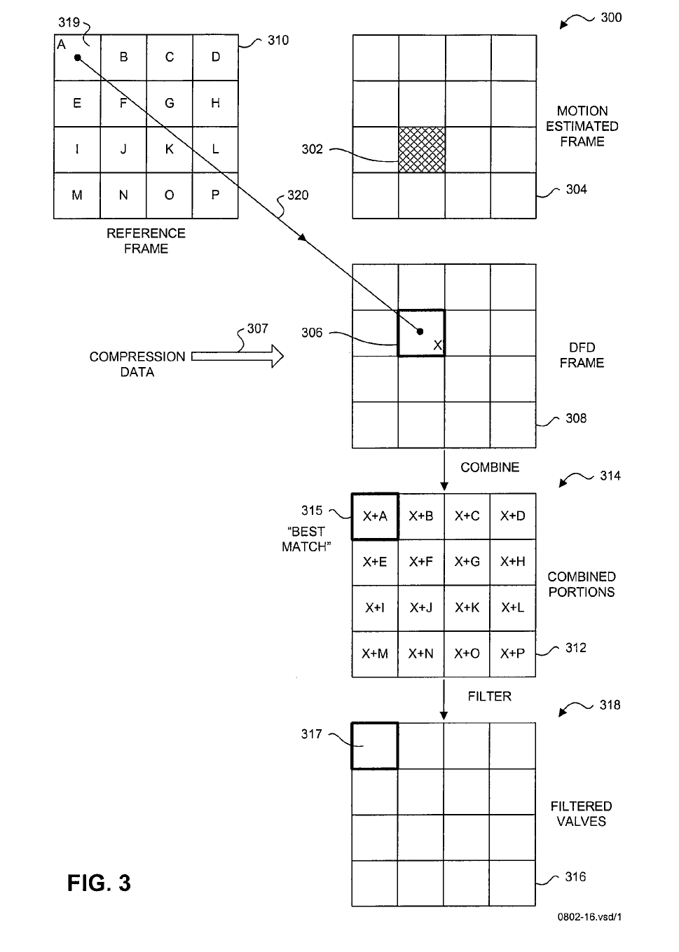

FIG. 3 is a conceptualization of an example video decoding scheme 300. In scheme 300, a decoder and/or decoding system may construct or produce a portion 302 of a motion estimated frame 304 by, at least in part, comparing a corresponding portion 306 of a decoded DFD frame 308 to portions or regions of a reference frame 310. In some implementations, DFD frame portion 306 may have been received as compressed image data conveyed in a bitstream 307 to a decoder by an encoder and/or encoding system implementing, for example, scheme 200 of FIG. 2. In other implementations, DFD frame portion 306 may be received as part of a stream of compressed video data received from, for example, storage media (e.g., a compact disk (CD)), a memory device (e.g., one or more memory integrated circuits (ICs)), etc.

In some implementations, a decoder may compare portion 306 to frame 310 by separately adding image data of portion 306 to at least some regions of reference frame 310 to produce a set or plurality of combined image portions. For example, adding image data of portion 306 to regions of frame 310 may generate a combined frame 312 having portions 314 representing separate additions of portion 306 with regions of frame 310. For example, if frame 310 includes sixteen regions of image data labeled A-P in FIG. 3, then portions 314 of combined frame 312 may comprise image data representing a sum of image data “X” of portion 306 with image data of separate ones of regions A-P of frame 310. While scheme 300 may depict regions A-P of frame 310 as having similar sizes to portion 306, claimed subject matter is not limited in scope in this regard, and, thus, one or more of regions A-P of frame 310 may be differently sized than portion 306. Moreover, while scheme 300 may depict each of regions A-P of frame 310 as having similar sizes and as not overlapping with each other, claimed subject matter is not limited in scope in this regard, and, thus, one or more of regions A-P of frame 310 may be differently sized than other regions and/or one or more of regions A-P of frame 310 may overlap. Many possible configurations and/or sizes of regions A-P of frame 310 and/or portion 306 are possible and are encompassed by claimed subject matter.

In some implementations, a decoder may filter portions 314 to produce a filtered frame 316 comprising filtered portions 318 representing filtered values. In this context, the term “filtering” includes multiplying individual image data values in an image portion by various combinations of neighboring image data values. In some implementations, portions 314 may be subjected to one of any number of well-known statistical filters such as edge filters, variance filters, nonlinear filters and/or higher order statistical filters to produce portions 318. For example, although claimed subject matter is not limited in scope to any particular filters or filtering methods, a decoder may subject portions 314 to a Sobel filter.

Alternatively, in other implementations, a decoder or decoding system may filter at least portion 306 of frame 308 and filter at least some of regions A-P of frame 310 before and in addition to filtering portions 314 of combined frame 316. Yet further, in other implementations, a decoder or decoding system may filter at least portion 306 of frame 308 and filter at least some of regions A-P of frame 310 without subsequently filtering portions 314 of combined frame 316, may filter portion 306 and not filter regions A-P of frame 310 before and in addition to filtering portions 314 of combined frame 316, may filter regions A-P of frame 310 and not filter portion 306 before and in addition to filtering portions 314 of combined frame 316, may filter portion 306 and not filter regions A-P of frame 310 without subsequently filtering portions 314 of combined frame 316, or filter regions A-P of frame 310 and not filter portion 306 without subsequently filtering portions 314 of combined frame 316.

While additional processing of combined portions 314 may be undertaken, it may be sufficient for a decoder to undertake a comparison by determining or identifying a combined portion that meets a particular condition. In some implementations, such a condition may comprise a variance condition of a least, lowest or minimum variance and a portion may meet a condition by exhibiting a least, lowest or minimum variance among portions 318. For example, a portion 317 of filtered frame 316 corresponding to a portion 315 of frame 312 may exhibit least variance. In this context, portion 315 may represent a best match or best alignment between reference frame 310 and portion 302 of estimated frame 304 where, in this context, the phrases “best match” and/or “best alignment” include a variance of portion 315, as exhibited by portion 317, meeting a particular condition, in this particular example: a variance condition of having least variance among portions 314. For a further example, when filtered using an edge filter, such as a Sobel filter, portion 315 of frame 312 may exhibit least variance among portions 314 by having a least number of edges as indicated by a value of portion 317. Claimed subject matter is not, however, limited in scope to the use of variance as a condition or metric for selecting a best match or alignment. Thus, for example, portion 315, associated with region 319 of reference frame 310, may be described as representing a best matching of portion 306 of frame 308 with reference frame 310 and/or as a best alignment of a corresponding portion 302 of estimated frame 304 with reference frame 310 based on any number of conditions and/or criteria.

In some implementations, a decoder may estimate a motion vector in response to determining a best match. Thus, if, for example, region 319 (“A”) of frame 310 comprises a best match for portion 306, a decoder may determine a motion vector 320 or displacement value describing a displacement required to map region 319 onto portion 306. Using such a determined or estimated motion vector 320, a decoder may construct portion 302 of estimated frame 304 by copying image data of region 319 and adding to it portion 306 of DFD frame 308.

In addition, a decoder undertaking a comparison of portion 306 to regions of frame 310 to produce an estimated motion vector, may, in some implementations of claimed subject matter, examine or use previously determined motion vectors for portions of frame 308 adjacent or near to portion 306 to do so. For example, previously determined motion vectors may comprise motion vectors that a decoder has previously estimated and/or motion vectors that an encoder has previously provided. Moreover, in determining vector 320, a decoder may also determine an associated reliability of estimated vector 320. In this context, the phrase “associated reliability” includes a motion vector confidence value.

Those skilled in the art may recognize that portions within image frames may overlap with one another and, further, that motion vectors may have sub-pixel resolution. Hence, those skilled in the art may further recognize that interpolation may be undertaken between image portions and/or metrics or conditions used to determine motion vectors. Thus, in some implementations, estimated motion vectors may be determined by undertaking comparisons between portions of image frames shifted or displaced with respect to other frame portions by, for example, fractions of pixels.

An encoder, having undertaken an encoding scheme such as scheme 200 to generate DFD frame 308, may provide, in accordance with some implementations of claimed subject matter, a bitstream 307 including additional information to inform a decoder undertaking scheme 300 how to determine or produce a motion vector. Thus, for example, an encoder may inform a decoder to estimate a motion vector in a manner similar to that described above. In some implementations, an encoder may further inform a decoder to estimate a motion vector in response, at least in part, to one or more previously determined motion vectors. Moreover, in some implementations, an encoder may inform a decoder to accept a motion vector provided with a particular image portion rather than inform the decoder to estimate a motion vector. Many additional implementations are possible consistent with claimed subject matter as described herein. Claimed subject matter is not limited in this regard however, and thus, in some implementations, an encoder may provide information that causes a decoder to estimate one or more motion vectors. In this sense, a decoder may undertake schemes such as scheme 300 in response to information provided by an encoder without being instructed by the encoder to do so.

Objects, elements, quantities etc. shown in scheme 300 are not necessarily intended to be shown to scale, and/or exhaustive in all details. For example, while frame 304, as shown, comprises sixteen image portions, those skilled in the art will recognize that an image or frame may, in fact, comprise a larger number of portions comprising, for example, macroblocks having 256 discrete pixel values, although claimed subject matter is not limited to any particular type, format, orientation and/or shape of image or frame portions. While a variety of well-known methods for determining motion vectors may be employed to implement a scheme like scheme 300, claimed subject matter is not limited in scope to any particular motion compensation scheme.

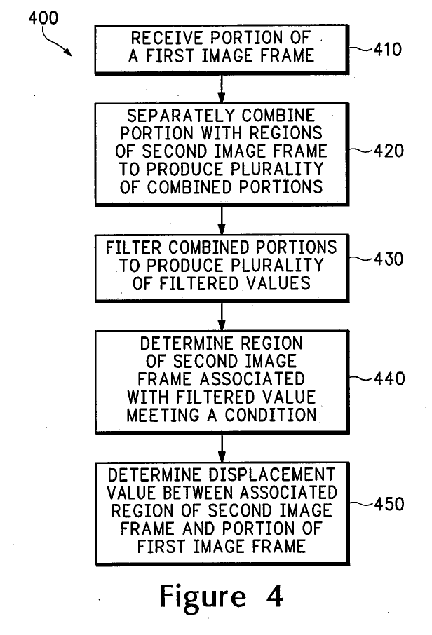

FIG. 4 is a flow diagram of a process 400 for video decoding. In block 410, a portion of a first image frame may be received. For example, an image frame portion may be received by a decoder in block 410 as part of a bitstream supplied by an encoder and/or may be received by a decoder after being retrieved from, for example, storage media (e.g., a CD), one or more memory ICs, etc. In some implementations, an image frame portion received in block 410 may be a portion of a DFD frame. At block 420, image data of an image frame portion received in block 410 may be separately combined with portions or regions of another or second image frame (e.g., a reference image frame) to produce a plurality of combined image portions. In some implementations, combining portions in block 420 may comprise having a decoder separately add image data of a portion received in block 410 to image data of regions of a reference frame previously received by the decoder.

In block 430, combined image portions may be filtered to produce filtered values. Filtering may, in various implementations, comprise having a decoder apply one or more of a number of well-known statistical filters such as edge filters, variance filters, and/or a higher order statistical filters to combined portions. For example, an edge filter such as a Sobel filter may be applied to combined portions. Although, again, claimed subject matter is not limited in scope to any particular filtering scheme.

At block 440, a reference frame portion may be determined as being associated with a filtered value meeting a condition. For example, although claimed subject matter is not limited in this regard, a condition may comprise an associated filtered value exhibiting a lowest variance. In this context, a decoder may determine that an image frame portion determined in block 440 may represent a best match or alignment between a reference frame region and a portion received in block 410. In block 450, a displacement value and/or motion vector may be determined associated with both a portion determined in block 440 and a portion received in block 410. For example, a decoder, having determined a best match in block 440, may determine a motion vector in block 450 describing a displacement of a best matching region of a reference frame with respect to a portion received in block 410.

The example process of FIG. 4 may include all, more than all, and/or less than all of blocks 410-450, and, furthermore, ordering of blocks 110-120 is merely an example order, and the scope of claimed subject matter is not limited in this respect. For example, in some implementations, filtering of image portions may occur before image portions are combined.

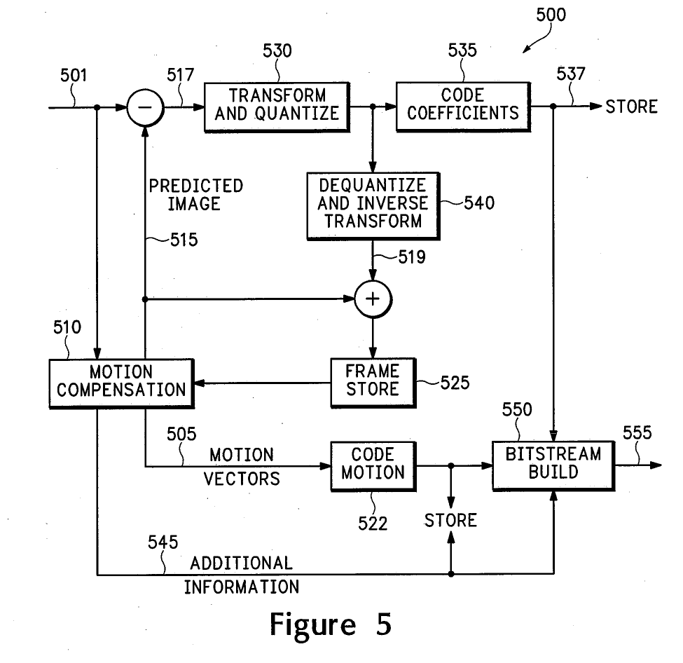

FIG. 5 is a block diagram of an example video encoder and/or encoding system 500. Encoder 500 may be included in any of a wide range of electronic devices, including digital cameras, camera-equipped cellular telephones, or other image forming devices, although claimed subject matter is not limited in this respect.

Encoder 500 may receive input image data 501 for a current original image. For this example implementation, a current original image may be an image frame from a digital video stream. A motion compensation block 510 may process data 501 to produce motion data including motion vectors 505 using any one of a number of well-known motion compensation techniques, claimed subject matter not being limited in scope in this regard. Vectors 505 may be encoded by a code motion block 522 to produce coded motion data that may then be transmitted and/or stored by encoder 500. Motion compensation block 510 may also produce predicted image data 515 in response to a previously processed image data held in frame delay or storage 525. Predicted image data 515 may be subtracted from current original image data 501 to form a motion residual 517. In some implementations, motion residual 517 may comprise a DFD frame.

Motion residual 517 may be received at a transform and quantize block 530 where it may be transformed and quantized using any one of a number of well-known image data transform and/or quantization techniques. For example, while block 530 may implement a Discrete Cosine Transform (DCT) technique to transform residual 517 into frequency domain coefficients, claimed subject matter is not limited in scope to any particular transform technique. Thus, for example, in other implementations, block 530 may implement well-known wavelet decomposition schemes to transform residual 517. Transformed data may then be quantized by block 530 using any number of well-known quantization techniques, claimed subject matter not being limited in scope in this regard. Transformed and quantized output from block 530 may be encoded by a code coefficients block 535 to produce coded image coefficients 537 which may be stored and/or transmitted by encoder 500.

Output from block 530 may also be provided to a de-quantize and inverse transform block 540 which may implement any of a number of well-known de-quantization and/or inverse transform techniques, consistent with the transform and quantization techniques performed by block 530, to provide a recovered residual image 519. Predicted image 515 may then be combined with residual image 519 recovered by block 540, and the result provided to frame storage 525 and hence motion compensation block 510 for use in coding of subsequent images.

In some implementations of claimed subject matter, encoder 500 may provide additional information 545 associated with at least some coefficients of coded image data 537. Additional information 545 may be used to inform a decoder to, for example, estimate a motion vector for associated coefficients (e.g., image portions) of data 537. For example, motion compensation block 510 may, in addition to generating motion vectors 505 associated with portions image data, also provide information 545 to inform a decoder to estimate a motion vector for other portions of image data. In other words, in some implementations, rather than providing a motion vector 505 with a portion of image data to a decoder, encoder 500 may provide information 545 to a decoder along with a particular portion of coded image data and use information 545 to inform a decoder that it should estimate a motion vector for that particular portion of image data. Further, in some implementations, encoder 500 may use information 545 to inform a decoder to estimate a motion vector for a given image portion in response to motion vectors associated with other image portions. In some implementations, additional information 545 may directly instruct a decoder to undertake some or all of such acts. However, claimed subject matter is not limited in this regard and, in other implementations, encoder may provide coded image data 537 without associated additional information.

Coded image data from block 535, related coded motion data from block 510, and/or related additional information 545 may be delivered to a bitstream build block 550 and incorporated into a bitstream 555 that may be transmitted to a decoder. Claimed subject matter is not, however, limited in scope to any particular bitstream schemes, protocols and/or formats. Encoder 500 may transmit bitstream 555 to a decoder using any of a wide variety of well-known transmission protocols, using any of a wide range of interconnect technologies, including wireless interconnect technologies, the Internet, local area networks, etc., although claimed subject matter is not limited in this respect. In some implementations, encoder 500 may store rather than transmit the coded image data from block 535, related coded motion data from block 510, and/or related additional information 545.

The various blocks and units of encoder 500 may be implemented using software, firmware, and/or hardware, or any combination of software, firmware, and hardware. Further, although FIG. 5 depicts an example system having a particular configuration of components, other implementations are possible using other configurations.

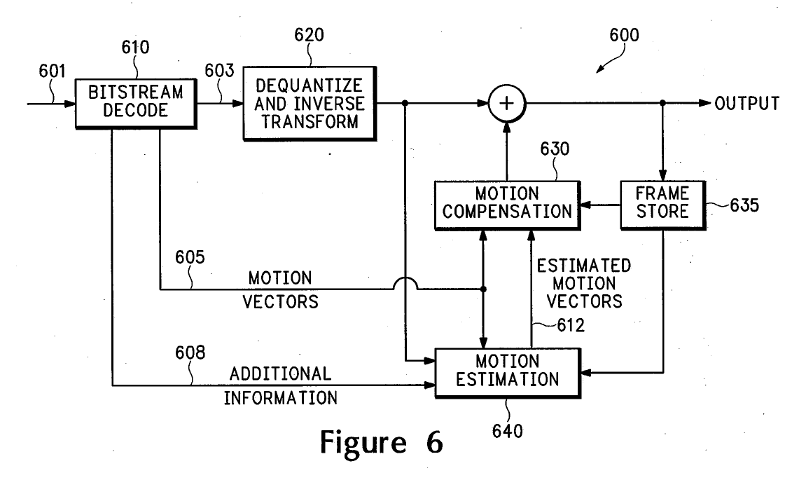

FIG. 6 is a block diagram of an example decoder and/or decoding system 600. Decoder 600 may be included in any of a wide range of electronic devices, including cellular telephones, computer systems, or other devices and/or systems capable of processing and/or displaying video images, although claimed subject matter is not limited in this respect. In some embodiments, decoder 600 may implement processes 100 and/or 300 and/or scheme 300 as described above.

A decode bitstream block 610 may receive a bitstream 601 including coded image data, coded motion data and/or additional information. In some implementations, bitstream 601 may include particular coded image portions and associated additional information instructing decoder 600 to estimate motion vectors for those particular image frame portions. In addition, in some implementations, bitstream 601 may also include additional information instructing decoder 600 to estimate motion vectors for particular image portions in response to previously determined and/or estimated and/or transmitted motion vectors. Although, claimed subject matter is not limited in this regard, and bitstream 601 may not include additional information.

Decode bitstream block 610 may provide decoded image data 603 to a de-quantize and inverse transform block 620. Block 620 may perform any one of a number of de-quantization and inverse transform techniques on image data 603 compatible with whatever transform and quantization techniques were employed by an encoder producing bitstream 601. Bitstream decode block 610 may also provide decoded motion vectors to a motion compensation block 630. Block 630 may use anyone of a number of well-known motion compensation techniques to modify output image data of block 620 held in frame storage 635, claimed subject matter not being limited in scope in this regard.

Bitstream decode block 610 may also provide additional information 608 associated with at least some portions of image data 603 to a motion estimation block 640. Information 608 may inform block 640 to estimate one or more motion vectors for particular portions of image data 603. To do so, block 640 may, in conjunction with other elements of decoder 600, implement processes 100 and/or 400 and/or decoding scheme 300 as described above. For example, in response to additional information 608, image data held in frame storage 635, decoded image data from block 620, and/or motion vectors 605 associated with some portions image data 603, motion estimation block 640 may produce estimated motion vectors 612 for other portions of image data 603. Block 640 may then supply those estimated motion vectors 612 to motion compensation block 630 for use in motion compensation of the associated image portions. In other implementations, block 640 may, in conjunction with other elements of decoder 600, implement processes 100 and/or 400 and/or decoding scheme 300 as described above without doing so in response to additional information.

The various blocks and units of decoding system 600 may be implemented using software, firmware, and/or hardware, or any combination of software, firmware, and hardware. Further, although FIG. 6 depicts an example system having a particular configuration of components, other implementations are possible using other configurations.

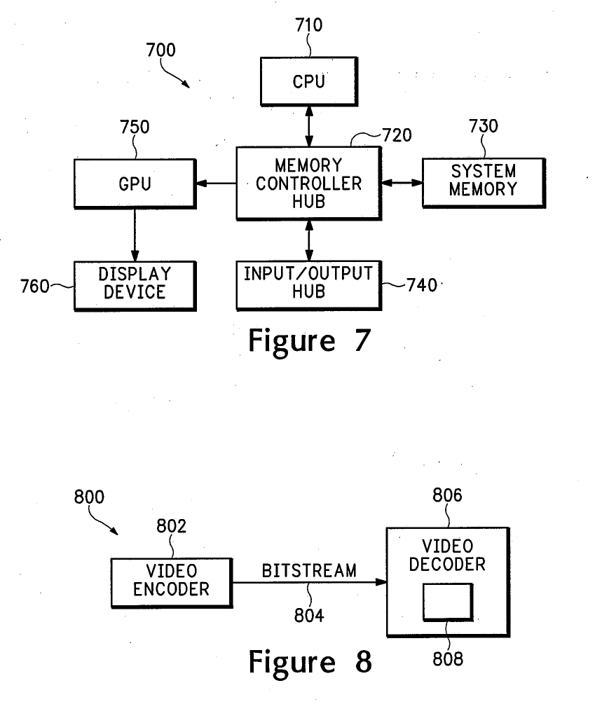

FIG. 7 is a block diagram of an example computer system 700 in accordance with some implementations of claimed subject matter. System 700 may be used to perform some or all of the various functions discussed above in connection with FIGS. 1-6. System 700 includes a central processing unit (CPU) 710 and a memory controller hub 720 coupled to CPU 710. Memory controller hub 720 is further coupled to a system memory 730, to a graphics processing unit (GPU) 750, and to an input/output hub 740. GPU 750 is further coupled to a display device 760, which may comprise a CRT display, a flat panel LCD display, or other type of display device. Although example system 700 is shown with a particular configuration of components, other implementations are possible using any of a wide range of configurations.

FIG. 8 is a block diagram of an example video transmission system 800 in accordance with some implementations of claimed subject matter. In accordance with some implementations of claimed subject matter, a video encoder 802 (e.g., system 500) may transmit or convey information 804 (e.g., in a bitstream) to a video decoder 806 (e.g., system 600) where that information includes compressed video data, such as coded portions of an error frame, as well as information informing or causing decoder 806 to use a motion estimation module 808 to estimate motion vectors by, in part, comparing portions of the error frame to previously provided and/or estimated regions of a reference video frame. To do so, decoder 806 may use module 808 to implement any or processes 100 or 400 and/or scheme 300.

In some implementations, encoder 802 may also transmit information causing decoder 806 to estimate motion vectors, at least in part, in response to previously estimated motion vectors. The information may additionally cause decoder 806 to estimate motion vectors using, at least in part, motion vectors provided by encoder 802. Thus, in some implementations, encoder 802 may transmit to decoder 806 a bitstream 804 that includes information causing decoder 806 to produce portions of motion estimated frames using motion vectors that decoder 806 estimates, produce other estimated frame portions using motion vectors that encoder 802 provides in the bitstream, and produce yet further estimated frame portions using motion vectors that decoder 806 has previously estimated and/or that encoder 802 has previously provided. In this context, encoder 802 and decoder 806 may be described as “communicatively coupled” in the sense that encoder 802 can communicate data, such as coded image data, and/or information, such as additional information, to decoder 806.

Claimed subject matter is not, however, limited to schemes wherein an encoder causes a decoder to estimate motion vectors. Thus, in some implementations, a decoder, such as decoder 806, may produce portions of motion estimated frames using motion vectors that the decoder estimates, produce other estimated frame portions using motion vectors that an encoder provides in a bitstream, and produce yet further estimated frame portions using motion vectors that the decoder has previously estimated and/or that an encoder has previously provided, all without having been caused to do so by an encoder (e.g., by additional information placed in a bitstream).

It will, of course, be understood that, although particular implementations have just been described, claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Likewise, although claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a system, such as a computer system, computing platform, or other system, for example, may result in an embodiment of a method in accordance with claimed subject matter being executed, such as one of the implementations previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive.

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations. Also, as used herein, the article “a” includes one or more items. Moreover, when terms or phrases such as “coupled” or “responsive” or “in response to” or “in communication with” are used herein or in the claims that follow, these terms should be interpreted broadly. For example, the phrase “coupled to” may refer to being communicatively, electrically and/or operatively coupled as appropriate for the context in which the phrase is used.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now, or in the future, occur to those skilled in the art. It is, therefore, to be understood that the appended claims are intended to cover all such modifications and/or changes as fall within the true spirit of claimed subject matter.

1. A method of decoding, comprising:
receiving at least part of a reference image frame;
receiving at least a portion of another image frame; and
determining a motion vector through comparing the portion of the another image frame and the part of the reference image frame.

2. The method of claim 1, wherein the determining step a motion vector further comprises:
determining the motion vector in response to additional information associated with the portion.

3. The method of claim 1, wherein the determining step further comprises:
determining the motion vector in response to previously determined ones of the motion vectors.

4. The method of claim 1, wherein the comparing step comprises:
separately combining the portion with the part to produce a plurality of combined portions; and
filtering the plurality of combined portions to produce a plurality of filtered values.

5. The method of claim 4, wherein filtering the plurality of combined portions comprises applying at least one of an edge filter, a variance filter, or a higher order statistical filter to the plurality of combined portions.

6. The method of claim 5, wherein the edge filter comprises a Sobel filter.

7. The method of claim 4, further comprising:
determining a region of the reference image frame associated with a respective one of the filtered values having a lowest variance.

8. The method of claim 7, further comprising:
determining a displacement value between the portion and the region associated with the filtered value having the lowest variance.

9. The method of claim 1, wherein the determining step comprises determining the motion vector's confidence value.

10. The method of claim 1, wherein said another image frame comprises a Displaced Frame Difference (DFD) frame.

11. (canceled)

12. An apparatus, comprising:
a decoder adapted to receive an image frame portion and to determine a motion vector by comparing the image frame portion and a plurality of reference frame portions.

13. The apparatus of claim 12, wherein the decoder is further adapted to determine the motion vector in response to additional information received from an encoder.

14. The apparatus of claim 12, wherein the decoder is further adapted to compare the image frame portion and the plurality of reference frame portions by:
adding the image frame portion to the plurality of reference frame portions to generate a plurality of combined frame portions; and
filtering the plurality of combined frame portions.

15. The apparatus of claim 14, wherein the filtering of the plurality of combined frame portions comprises applying at least one of an edge filter, a variance filter, or a higher order statistical filter to the plurality of combined frame portions.

16. The apparatus of claim 14, wherein the edge filter comprises a Sobel filter.

17. The apparatus of claim 12, wherein the decoder is further adapted to determine the motion vector in response to previously determined ones of the motion vectors.

18. The apparatus of claim 12, wherein the image frame comprises a DFD frame.

19. (canceled)

20. An apparatus, comprising:
an encoder adapted to:
produce a bitstream including at least a portion of an image frame; and
provide information to a decoder, wherein the decoder is configured to predict a motion vector using the portion of the image frame.

21. The apparatus of claim 20, wherein the encoder is further adapted to provide information to a decoder, wherein the decoder is configured to predict the motion vector in response to other motion vectors.

22. The apparatus of claim 20, wherein the image frame comprises a DFD frame.

23. A method, comprising:
transmitting information from an encoder to a decoder, the information comprising codes indicative of a portion of an image frame, the information causing the decoder to estimate a motion vector using the portion of the image frame.

24. The method of claim 23, the information further causing the decoder to estimate the motion vector in response to other motion vectors.

25. The method of claim 23, wherein the image frame comprises a DFD frame.

26. The method of claim 23, wherein the information includes codes indicative of other motion vectors.

27. A system, comprising:
an encoder adapted to provide a bitstream including codes indicative of a portion of an image frame; and
a decoder communicatively coupled to the encoder, the decoder adapted to decode the bitstream and to determine estimate a motion vector using the portion of the image frame.

28. The system of claim 27, wherein the decoder is coupled to the encoder via at least one of a wireless interconnect, a local area network, and an Internet.

29. The system of claim 27, wherein the decoder is adapted to determine the motion vector by comparing the portion of the image frame and portions of a reference frame.

30. The system of claim 27, wherein the image frame comprises a DFD frame.

31. The system of claim 27, wherein the decoder is further adapted to determine the motion vector in response to additional information associated with the portion of the image frame received from the encoder.

32. A tangible computer readable storage medium having computer program code recorded thereon that when executed by a processor produces desired results, the computer readable storage medium comprising:
computer program code that enables the processor to receive at least part of a reference image frame at the decoder;
computer program code that enables the processor to receive a portion of another image frame at the decoder; and
computer program code that enables the processor to determine estimating a motion vector through comparing the portion of another image frame and the part of the reference image frame.

33. The tangible computer readable storage medium of claim 32, wherein said computer program code further comprising:
computer program code that enables the processor to determine estimating the motion vector in response to additional information associated with the portion.

34. The tangible computer readable storage medium of claim 32, wherein said computer program code for estimating the motion vector further comprising:
computer program code that enables the processor to determine estimating the motion vector through previously determined ones of the motion vectors.

35. The tangible computer readable storage medium of claim 32, wherein said computer program code for comparing the portion and the pad further comprising:
computer program code that enables the processor to separately combine the portion with one or more of the parts to produce a plurality of combined portions; and
computer program code that enables the processor to filter the plurality of combined portions to produce a plurality of filtered values.

36. The tangible computer readable storage medium of claim 35, wherein said computer program code for filtering the combined portions further comprising:
computer program code that enables the processor to apply applying at least one of an edge filter, a variance filter, and a higher order statistical filter to the plurality of combined portions.

37. The tangible computer readable storage medium of claim 36, wherein the edge filter comprises a Sobel filter.

38. The tangible computer readable storage medium of claim 35, wherein said computer program code further comprising:
computer program code that enables the processor to determine a region of the reference image frame associated with a respective one of the filtered values having a lowest variance.

39. The tangible computer readable storage medium of claim 38, wherein said computer program code further comprising:
computer program code that enables the processor to determine a displacement value between the portion and the region associated with the filtered value having the lowest variance.

40. The tangible computer readable storage medium of claim 32, wherein said computer program code for determining the motion vector further comprising:
computer program code that enables the processor to determine the motion vector's confidence value.

41. (canceled)

42. The tangible computer readable storage medium of claim 32, wherein said another image frame comprises a DFD frame.

43. A tangible computer readable storage medium having computer program code recorded thereon that when executed by a processor produces desired results, the computer readable storage medium comprising:
computer program code that enables the processor to transmit information from an encoder to a video decoder, the information including codes indicative of a portion of an image frame, the information causing the decoder to determine a motion vector using the portion of the image frame.

44. The tangible computer readable storage medium of claim 43, the information further causing the decoder to estimate determine the motion vector in response to other motion vectors.

45. The tangible computer readable storage medium of claim 43, wherein the image frame comprises a DFD frame.

46. The tangible computer readable storage medium of claim 43, wherein the information includes codes indicative of other motion vectors.

47. A system, comprising a decoder configured to produce at least some portions of an image frame by determining motion vectors.

48. The system of claim 47, wherein the decoder is configured to determine motion vectors though information received from an encoder.

49. The system of claim 48, wherein the information is provided to the decoder in a bitstream that also conveys motion vectors.

50. The system of claim 49, wherein the decoder is further configured to use the motion vectors conveyed in the bitstream to produce at least other portions of the image frame.

51. The system of claim 48, wherein the information causes the decoder to motion vectors.

52. The system of claim 48, wherein the information also causes the decoder to produce other portions of the image frame through at least one of previously determined motion vectors and previously conveyed motion vectors.

53. The system of claim 47, wherein the decoder is configured to determine motion vectors by applying statistical filters.

54. The system of claim 47, wherein the decoder is configured to determine motion vectors by comparing portions of an error image frame and portions of a reference image frame.

55. The method of claim 1, wherein comparing the portion and the part further comprises:
filtering the portion to produce a filtered portion value.

56. The method of claim 1, wherein comparing the portion and the part further comprises:
filtering the part to produce region values.

57. The method of claim 55, wherein comparing the portion and the part further comprises:
filtering the part of the reference image frame to produce filtered region values.

58. The method of claim 57, wherein comparing the portion and the part further comprises:
separately combining the filtered portion value with the filtered region values to produce a plurality of combined values.

59. The method of claim 53, wherein comparing the portion and the part further comprises:
filtering the plurality of combined values.

60. The apparatus of claim 12, wherein the decoder is further adapted to compare the image frame portion and the plurality of reference frame portions by filtering the image frame portion to a produce a filtered portion value.

61. The apparatus of claim 12, wherein the decoder is further adapted to compare the image frame portion and the plurality of reference frame portions by filtering regions of the reference frame to produce filtered region values.

62. The apparatus of claim 60, wherein the decoder is further adapted to compare the image frame portion and the plurality of reference frame portions by filtering regions of the reference frame to produce filtered region values.

63. The apparatus of claim 62, wherein the decoder is further adapted to compare the image frame portion and the plurality of reference frame portions by separately combining the filtered portion value with the filtered region values to produce a plurality of combined values.

64. The apparatus of claim 63, wherein the decoder is further adapted to compare the image frame portion and the plurality of reference frame portions by filtering the plurality of combined values.

65. The tangible computer readable storage medium of claim 32, wherein said computer program code for comparing the portion and the part farther comprises:
computer program code that enables the processor to filter the portion to produce a filtered portion value.

66. The tangible computer readable storage medium of claim 32, wherein said computer program code for comparing the portion and the part comprises:
computer program code that enables the processor to filter the part to produce filtered region values.

67. The tangible computer readable storage medium of claim 65, wherein said computer program code for comparing the portion and the part further comprises:
computer program code that enables the processor to filter the part to produce filtered region values.

68. The tangible computer readable storage medium of claim 67, wherein said computer program code for comparing the portion and the part further comprises:
computer program code that enables the processor to separately combine the filtered portion value with the filtered region values to produce a plurality of combined values.

69. The tangible computer readable storage medium of claim 68, wherein said computer program code for comparing the portion and the part further comprises:
computer program code that enables the processor to filter the plurality of combined values.
